(19) United States
(12) Patent Application Publication
(10) Pub. No.: US 2023/0087957 A1
(43) Pub. Date: Mar. 23, 2023

(54) RESERVATION MANAGEMENT SYSTEM, RESERVATION MANAGEMENT METHOD, AND STORAGE MEDIUM

(71) Applicant: CASIO COMPUTER CO., LTD., Tokyo (JP)

(72) Inventor: Tomoyuki NAGAO, Tokyo (JP)

(21) Appl. No.: 17/950,003

(22) Filed: Sep. 21, 2022

(30) Foreign Application Priority Data
Sep. 22, 2021 (JP) 2021-154422

(51) Int. Cl. G06Q 10/02; G06Q 10/06; A45D 29/00

(52) U.S. Cl. CPC G06Q 10/02; G06Q 10/063114; G06Q 10/06398; A45D 29/00; A45D 2029/005

(57) ABSTRACT

A reservation management system includes at least one processor. The at least one processor is configured to accept a reservation of at least one step in a task including a plurality of steps, and the step is performed for each user. The at least one processor is configured to derive estimated required time that is necessary to perform an entire task including the reserved step performed for each user. The at least one processor is configured to accept input of a progress status of each step performed for each user. The at least one processor is configured to update the estimated required time based on the input progress status.

### CROSS-REFERENCE TO RELATED APPLICATIONS

This application is based upon and claims the benefit of priority under 35 USC 119 of Japanese Patent Application No. 2021-154422, filed on Sep. 22, 2021, the entire disclosure of which, including the description, claims, drawings, and abstract, is incorporated herein by reference in its entirety.

### BACKGROUND

### 1. Field of Invention

The present disclosure relates to a reservation management system, a reservation management method, and a storage medium.

### 2. Description of the Related Art

Conventionally, for example, there are known stores that provide various services (beauty care related services) such as nail salons or beauty salons. When a user desires to receive service at such stores, the user needs to check a reservation status of the store and an availability status of the store. Then, the user needs to make an appointment.

For example, JP 2003-6492 proposes a reservation management system that compares the reservation status of the store with a time slot that a customer can visit the store. When a certain customer is selected, information regarding an available slot that can be reserved is sent to a terminal apparatus owned by the selected customer.

However, such reservation management system does not reflect the real time reservation status of the store.

For example, a user may suddenly desire to receive service (various types of treatment) and may desire to check the reservation status at the present time or the user may desire to receive the service depending on the reservation status (waiting time). In such cases, the user may desire to determine whether to visit the store or make a reservation depending on how much free time the user has at the moment or the present reservation status (waiting time). In such case, according to a system as described in JP 2003-6492, if the time that the user is able to visit the store is not determined, the system cannot flexibly accept reservations according to the situation of the user.

### BRIEF SUMMARY OF THE INVENTION

A reservation management system including at least one processor configured to: accept a reservation of at least one step in a task including a plurality of steps, wherein the step is performed for each user, derive estimated required time that is necessary to perform an entire task including the reserved step performed for each user, accept input of a progress status of each step performed for each user, and update the estimated required time based on the input progress status.

### BRIEF DESCRIPTION OF THE SEVERAL VIEWS OF THE DRAWINGS

FIG. 1 is a system configuration showing a schematic configuration of a reservation management system according to the present embodiment.

FIG. 2 is a perspective view of the main components showing an external configuration of the printing apparatus included in the reservation management system according to the present embodiment.

FIG. 3 is a block diagram of a main portion showing a functional configuration of the printing apparatus included in the reservation management system according to the present embodiment.

FIG. 4 is a block diagram of a main portion showing a functional configuration of a terminal apparatus included in the reservation management system according to the present embodiment.

FIG. 5 is a block diagram of a main portion showing a functional configuration of a reservation management server included in the reservation management system according to the present embodiment.

FIG. 6 is a diagram showing an example of the reservation management information.

FIG. 7 is a diagram showing an example of the reservation management information.

FIG. 8 is a flowchart showing reservation management according to the present embodiment.

### DETAILED DESCRIPTION OF THE INVENTION

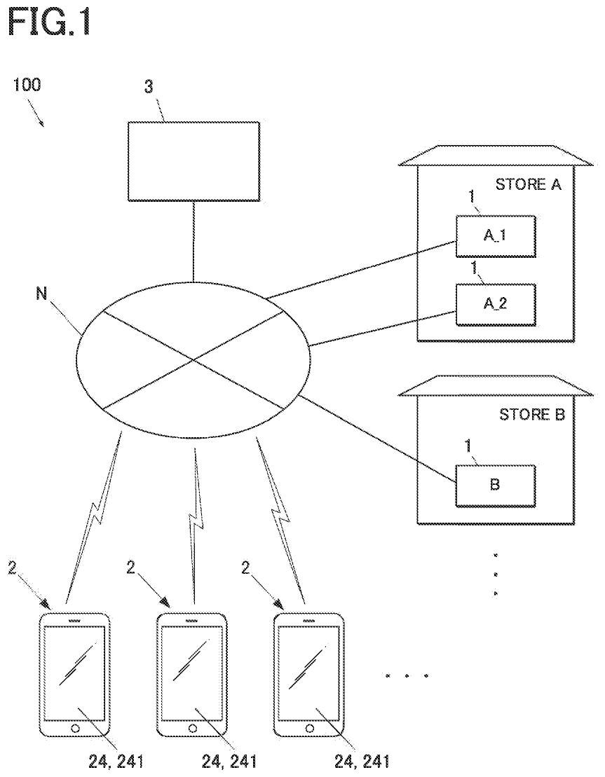

With reference to FIG. 1 to FIG. 8, described below are embodiments regarding the reservation management system, the reservation management method, and the storage medium regarding the present disclosure.

Various limitations technically suitable to perform the present disclosure are added to the embodiments below. However, the scope of the present disclosure is not limited to the embodiments and the illustrated examples.

In the embodiments below, an example in which the reservation management system is a system that manages a reservation of a printing apparatus (nail print apparatus) provided in a store such as a nail salon or a beauty salon is described. However, the reservation management system is not limited to a reservation of a printing apparatus.

### [Overall Configuration]

FIG. 1 is a diagram showing an entire configuration of a reservation management system according to the present embodiment.

As shown in FIG. 1, a reservation management system 100 according to the present embodiment includes a plurality of printing apparatuses 1 provided in a store (store A, store B in FIG. 1), a terminal apparatus 2 in a hand of a user, and a reservation management server 3 that manages the reservations of each printing apparatus 1.

Such printing apparatuses 1, terminal apparatus 2, and reservation management server 3 are connected to each other to be able to communicate information among each other through a network N such as the internet.

According to the illustrated examples, two printing apparatuses 1 are provided in the store A (printing apparatus A_1, printing apparatus A_2) and one printing apparatus 1 is provided in the store B (printing apparatus B). The number of stores provided in the reservation management system 100 and the number of printing apparatuses 1 provided in each store is not limited to the above example.

The number of user terminal apparatuses 2 that can access to the reservation management system 100 is also not limited to the illustrated example.

As described below, in the reservation management system 100 according to the present embodiment, by operating an operator 12 of the printing apparatus 1 and an operator 23 of the terminal apparatus 2, reservations (reserved contents) regarding tasks that include a plurality of steps and progress status of the steps can be input.

Here, “task” means treatment to perform printing on the nail. According to the present embodiment, “task” assumes treatment to perform printing on the nail using the printing apparatus 1. Here, printing on the nail refers to a series of processes in the treatment performed on the nail, the processes including, applying various coatings on the nail, printing designs on the nail, and the like.

The “task” is not limited to the treatment to perform printing on the nail and may widely include various treatment such as haircuts and dying the hair at beauty salons. The “plurality of steps” in the treatment are described later.

The “reserved contents” are contents of the treatment that the user desires to receive, that is, a treatment package. As the treatment package, various situations are assumed, for example, a situation in which the printing on the nail is performed, a situation in which a base coat is applied by hand by the staff of the store (professional technician), and only the design is printed using the printing apparatus 1 (nail print apparatus), a situation in which both the base coat and the design are printed using the printing apparatus 1, a situation in which the user applies the base coat at home, or somewhere else and only the design is printed at the store, or a situation in which after the design is printed, the staff of the store (professional technician) further adds rhinestones, decorative glitter or the like. Moreover, before or after the printing on the nail or concurrently with the printing on the nail, other treatments such as haircuts may be performed. Further, there may be situations such as regarding the processes performed by the staff of the store (professional technician), a user appoints the staff with high skills, or the staff with low skills becomes in charge of the process.

The time required to complete the treatment that is reserved (estimated required time) differs depending on the contents in the treatment package that the user reserved. Moreover, such estimated required time becomes shorter as the steps included in each task progresses.

According to the reservation management system 100 of the present embodiment, when the steps in each task end or the process progresses to the next step, such information regarding the progress status is obtained by the reservation management server 3. The method that the reservation management server 3 obtains the progress status of each step is not limited. For example, when each step ends, a notification that the step is finished may be sent automatically from the printing apparatus 1 to the reservation management server 3. For example, when the staff of the store or the user inputs on the operator 12 of the printing apparatus 1, the contents of the input is transmitted to the reservation management server 3. The user may input on the operator 23 of the user's terminal device 2, and the contents of the input may be transmitted to the reservation management server 3.

The present embodiment assumes a situation in which a plurality of printing apparatuses 1 are registered in the reservation management system 100, and the information of the registered printing apparatuses 1 is centrally managed by the registration management server 3. Then, when there is access from the user who desires to make a reservation, based on the information regarding the reservations that are already accepted and the information regarding the progress status later on, the reservation management server 3 outputs to the terminal apparatus 2 of the user the information showing how long the user needs to wait until the user can receive the treatment in which printing apparatus 1 of which store (the estimated required time of the treatment already reserved and the waiting time derived from the estimated required time).

The apparatuses included in the reservation managing system 100 are described in detail below.

### [Configuration of Printing Apparatus]

The printing apparatus 1 is an apparatus that prints a design (nail design) on a surface of the nail. The target on which printing is performed by the printing apparatus 1 is fingernails of hands (not shown). The target on which printing is performed by the printing apparatus is not limited to the fingernails of the hands. The target of printing may be toenails of feet, nail shaped goods such as artificial nails, various accessories, and the like.

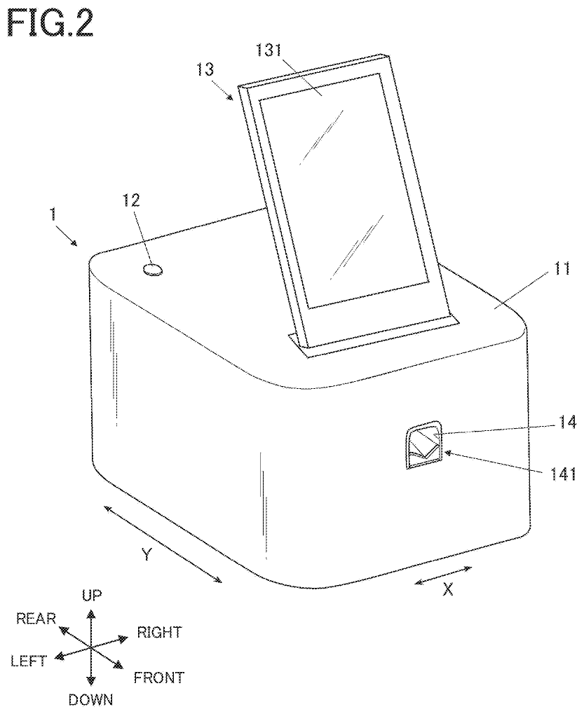

FIG. 2 is a perspective view showing the external configuration of the main components of the printing apparatus according to the present embodiment.

In the embodiments described below, up-down, left-right, and front-rear are directions as shown in FIG. 2. X-direction and Y-direction are directions as shown in FIG. 2.

As shown in FIG. 2, the printing apparatus 1 includes a case 11 formed in a substantial box shape.

An opening 14 is formed in substantially the center in the left-right direction (horizontal direction of printing apparatus 1, left-right direction in FIG. 2, X-direction) on the front side of the case 11 (front side of the printing apparatus 1, front side in FIG. 2). The opening 14 includes a width and a height in which a finger corresponding to the nail that is the printing target can be inserted in and pulled out from the apparatus.

According to the present embodiment, a finger placer 141 is provided on an inner side of the opening 14 inside the case 11. The finger (not shown) corresponding to the nail that is the target of printing is placed on the finger placer 141. Although not illustrated, preferably, the finger placer 141 includes a configuration to fix the placed finger, and the finger is regulated in the height direction.

The height, width, and length in the depth direction of the finger placer 141 is to be a height and a width so that the finger can be placed stably, but the specific dimensions are suitably set.

An operator 12 is provided on an upper surface (top board) and a lateral surface of the case 11.

The operator 12 is a functional unit with which the user performs various input. The operator 12 may be, for example, a power switch button that turns on and turns off the power of the printing apparatus 1, or a stop switch button that stops the operation. When the operator 12 is operated, the instruction signal according to the operation is output to the later-described controller 101.

According to the present embodiment, the input of the progress status of each step is performed by operation on the operator 12 (including touch panel included in the display 13). The input progress status is transmitted to the reservation management server 3 through the later-described communicator 19, and is accepted by the controller 31 of the reservation management server 3. The method of inputting the progress status is not limited. For example, a plurality of steps included in the reserved treatment are displayed in a list on a touch panel included in the display 13. When a certain step ends, the step is selected and an end button provided for the step is pressed.

According to the illustrated example, the operator 12 is one button provided on the upper surface of the case 11. Alternatively, the operator 12 may be provided in a position other than the upper surface of the case 11, and a plurality of buttons may be included in the operator 12.

The printing apparatus 1 may operate by input operation from the later-described operator 23 of the terminal apparatus 2.

For example, when a user who reserved treatment such as printing on nails which is a task including plurality of steps visits the location where the printing apparatus 1 is provided such as the store, a confirmation screen in which it is possible to confirm the reserved contents may be displayed by operating the touch panel included in the display 13. In this case, the required time for each step in the reserved task may be displayed as a list and confirmed by the user. According to the above, the user is able to check in detail how much time will be consumed to receive the desired treatment when the user arrives at the store. Here the user may change (for example, omit some steps or add optional steps) “contents of reservation”, etc. (package of treatment) on the confirmation screen.

For example, when the reservations of the printing apparatus 1 are already full when the user visits the location where the printing apparatus 1 is provided such as the store, there may be a case in which the user makes a reservation at the store to be scheduled an hour later and then leaves the store for a while. In view of the above, the printing apparatus 1 may be configured so that the user is able to make a reservation of the treatment on the operator 12 of the printing apparatus 1, for example (including touch panel included in display 13). In this case, for example, a reservation screen to perform a reservation is displayed as the operation screen on the touch panel included in the display 13.

As the “reserved contents”, the following items can be assumed, for example, the finger of the nail that the printing is performed on (10 fingers of both hands, only 5 fingers of either the left or right hand), whether the base coat is applied, whether the user desires the staff of the store to manually apply the base coat, whether the user desires printing by the printing apparatus 1, selection of the design that the user desires to be printed as the nail design, whether to perform decorative processes such as applying rhinestones, whether to perform other supplementary tasks in addition to the printing of the nail which is the main task, contents of the supplementary task when such task is performed (for example, haircut, etc.), and the like.

The display 13 is provided on the upper surface of the case 11.

For example, the display 13 includes a liquid crystal display (LCD), an organic electroluminescent display (organic ELD), or other display device 131 (flat display). The display 13 displays various images and information on the display device 131 based on the display signal input from the later-described controller 101.

The display device 131 of the display 13 according to the present embodiment is formed as one with the touch panel, and is able to accept touch operation by the user. The touch panel included in the display device 131 also functions as the operator 12 in order to perform various input. When the touch panel functions as the operator 12, the progress status of each step can be input by touch operation on the touch panel. Input may be made by touch operation on the touch panel in order to reserve tasks including a plurality of steps. The input progress status is transmitted to the reservation management server 3 through the later-described communicator 19 and the controller 31 of the reservation management server 3 accepts the input progress status. The display 13 is not limited to a display provided as one with the printing apparatus 1. For example, a smartphone that is detachable from the case 11 of the printing apparatus 1 or a portable terminal apparatus such as a tablet type terminal apparatus (hereinafter referred to as tablet PC (Personal Computer)) may function as the display or touch panel of the printing apparatus.

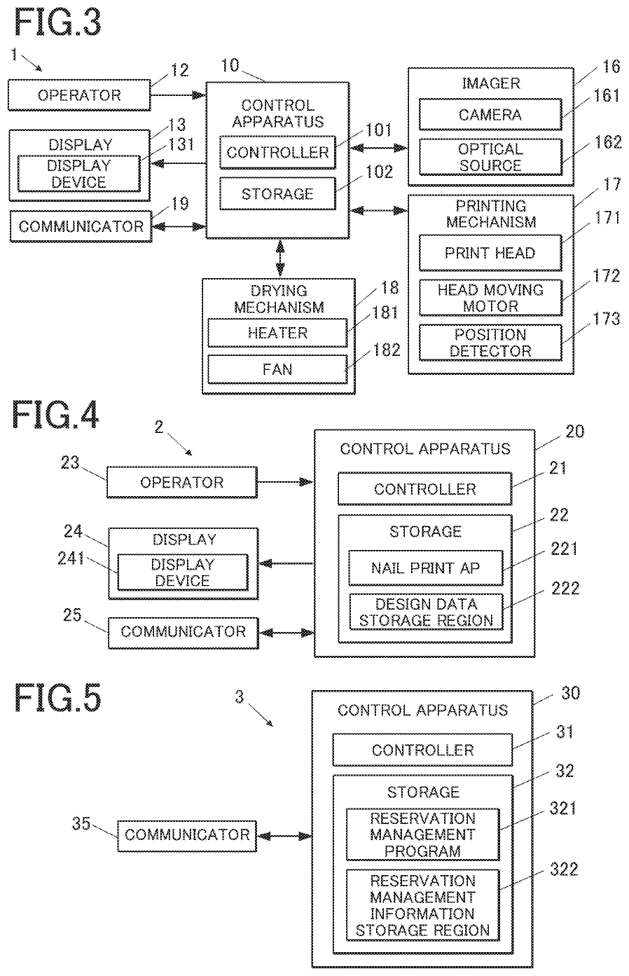

FIG. 3 is a block diagram of a main portion showing a control configuration of the printing apparatus according to the present embodiment.

As shown in FIG. 3, in addition to the above-described operator 12 and the display 13, the printing apparatus 1 includes an imager 16, a printing mechanism 17, a drying mechanism 18, a communicator 19, and a control apparatus 10.

The imager 16 includes a camera 161 and an optical source 162.

The camera 161 images the nail of the finger positioned in the finger placer 141 and obtains an image of the nail that is the target of printing.

The optical source 162 is an illumination lamp such as a white LED.

The printing mechanism 17 includes a print head 171 and a head moving motor 172 that moves the print head 171.

The print head 171 is for performing a printing process in which a design (nail design) is printed on the surface of the nail that is the printing target (printing target surface).

The print head 171 according to the present embodiment is an inkjet printing device that forms fine droplets of ink, sprays (ejects) the ink directly on the surface of the nail that is the printing target, and performs printing. The specific method to eject the ink is not limited.

As the print head 171 of the present embodiment, print heads for printing designs are provided, and the color ink in the colors cyan (C), magenta (M), and yellow (Y) can be discharged. According to the present embodiment, in addition to the print head that ejects color ink as described above, a print head is provided for the base coat that prints liquid that is to be the base coat before printing the design (base coat ink such as white color ink, for example). The type and the number of print heads 171 is not limited.

The head moving motor 172 includes a moving mechanism that moves the print head 171 in the left-right direction (X-direction) and front-rear direction (Y-direction) of the apparatus. The head moving motor 172 is a step motor, for example, and accurately moves the print head 171 as necessary in the X-Y direction.

The printing mechanism 17 includes a position detecting sensor 173 that detects the position of the print head 171. The position detecting sensor 173 is an origin sensor that detects a position of the origin in the X-direction and the Y-direction of the print head 171 and an encoder sensor that senses the state of movement of the print head 171. The specific type and configuration of the position detecting sensor 173 is not limited.

The drying mechanism 18 performs the drying step in which the ink applied to the surface of the nail by the print head 171 (or applied manually) is dried.

The drying mechanism 18 includes a heater 181 for heating and a fan 182 for sending wind. By operating the heater 181 and the fan 182, warm air is sent to the nail. The specific configuration of the heater 181 and the fan 182 is not limited. It is not essential that the drying mechanism 18 be provided in the printing apparatus 1. However, it is preferable that the time required for drying is shortened by drying the ink with the drying mechanism 18.

According to the present embodiment, the printing apparatus 1 can be connected to the network N, and the printing apparatus 1 includes a communicator 19 that can connect to a network.

According to the present embodiment, in a situation in which a reservation is made regarding “a task including a plurality of steps”, when the estimated required time necessary for performing all steps in the reserved task is derived or when the estimated required time is updated based on the input progress status, the information such as the latest estimated required time is output from the reservation management server 3. In this case, the information of the latest estimated required time is transmitted through the communicator 19 to the printing apparatus 1 in which the reservation is made. In this case, the user who received the treatment using the printing apparatus 1 is able to know the progress status of the treatment in real time. Then, the user is able to check as necessary the steps that are left and the amount of time that is necessary until the total treatment is completed.

The reservation regarding the “task including the plurality of steps” and the progress status of each step can be input on the operator 12 (including touch panel included in the display 13), and in this case, the input reserved contents and the input progress status are transmitted to the reservation management server 3 through the communicator 19.

When the printing apparatus 1 obtains data regarding the design printed on the nail (nail design) from an external device (for example, various terminal devices, servers, etc.), communication with various external devices is performed by wireless communication based on short-range wireless communication standards such as Bluetooth (registered trademark), WiFi, etc., communication by wireless LAN, communication by wired communication, and the like. The method of communication is not limited. The method of communication may be suitably selected from various communication methods.

The control apparatus 10 provided in the printing apparatus 1 is a computer including a controller 101 including a processor such as a CPU (Central Processing Unit) (not shown), storage 102 including a ROM (Read Only Memory) and RAM (Random Access Memory) (both not shown), etc.

Various programs and various data are stored in the ROM of the storage 102 to operate the printing apparatus 1.

The controller 101 deploys in the work area of the RAM various programs stored in the ROM, etc. and executes the various programs, and the operation of each unit of the printing apparatus 1 is integrally controlled.

That is, the controller 101 executes various functions in coordination with the program (for example, printing process program, etc.) so that the printing apparatus 1 performs the printing process.

### [Configuration of Terminal Apparatus]

The terminal apparatus 2 is an apparatus in the user's hands.

As shown in FIG. 1, according to the present embodiment, the plurality of terminal apparatuses 2 assumes connecting the later-described reservation management server 3 through the network N.

For example, as the terminal apparatus 2, the portable terminal apparatus that the user can use outside is assumed, examples including a smartphone, tablet PC, cell phone, and the like. The terminal apparatus 2 is not limited, and may include a notebook PC, desktop PC, and the like.

FIG. 4 is a block diagram of a main portion showing the functional configuration of the terminal apparatus.

As shown in FIG. 4, the terminal apparatus 2 includes, a control apparatus 20, an operator 23, a display 24, a communicator 25, and the like.

The control apparatus 20 is a computer including a controller 21 including the processor such as a CPU (not shown), and a storage 22 including a ROM and a RAM (not shown).

The controller 21 controls a unit of the terminal apparatus 2. The controller 21 reads the specified program among the system program and the application programs stored in the storage 22, and deploys the program in the work area of the RAM. The controller 21 performs various processes according to the program.

Specifically, according to the present embodiment, a nail print application program 221 (hereinafter referred to as nail print AP) is stored in the storage 22. In coordination with such programs, the controller 21 executes various functions regarding the nail printing using the printing apparatus 1.

The design data storage region 222 is provided in the storage 22. The data of the design (nail design) used in the nail print is stored in the design data storage region 222.

The operator 23 is configured so that various input and setting can be performed according to the operation by the user. For example, the operator 23 is a touch panel provided as one with the display device 241 of the later-described display 24. When the operator 23 is operated, the input signal corresponding to the operation is transmitted to the controller 21.

Various operation screens are displayed on the touch panel included in the display 24 according to the control by the controller 21. The user is able to perform the operation of various input and setting by touch operation on the touch panel. The operator 23 for performing operation of various input and setting is not limited to a touch panel.

According to the present embodiment, the user is able to make a reservation from the operator 23 of the terminal apparatus 2 in order to receive treatment such as printing on the nail which is a task including a plurality of steps. For example, as the operation screen, the reservation screen in order to make the reservation is displayed on the touch panel included in the display 24.

The reservation, etc. input from the operator 23 is transmitted to the reservation management server 3 through the later-described communicator 25 as necessary, and the input reservation is accepted by the controller 31 of the reservation management server 3.

The “reserved contents” (treatment package) desired by the user can be input and set on the reservation screen.

The specific display contents of the reservation screen are suitably set items.

For example, when the terminal apparatus 2 accesses to the reservation management server 3, the user is able to narrow down the printing apparatus 1 (nail print apparatus) that can be reserved by items such as “search store by location” “search store close to present position”, and the printing apparatus 1 that can be reserved and selected are displayed on the screen as the reservation screen. When the user selects the item, the candidate of the store and the candidate of the printing apparatus 1 provided in the store are displayed on the touch panel according to the selection by the user. The user is able to select the desired store and the printing apparatus 1 from the above.

The reservation status for each printing apparatus 1 is displayed as the information to support the selection of the printing apparatus 1 by the user (that is, the selection of which printing apparatus 1 to reserve) on the reservation screen. The contents that are displayed as the reservation status are suitably set. Preferably, if there is a user that already made a reservation at the present point, the number of people waiting and the reserved contents are displayed. Moreover, preferably, if there is a user who already started treatment, the contents of the treatment package (reserved menu), the progress status of the treatment (progressed to which step), the estimated required time, the assumed waiting time calculated by adding the estimated required time of the users who made reservations, or the like are displayed. As described later, the estimated required time is suitably updated according to the degree of progress of the steps.

As the information to support the user's selection of the printing apparatus 1, the address and the phone number of the store, the distance of the store from the present position of the user, or the like may be displayed on the reservation screen.

When the user inputs the type of treatment package that the user desires to reserve on the reservation screen, the specific contents of the treatment package (the contents of each step and the required time for each step consisting the reserved “task including the plurality of steps”) may be displayed on the reservation screen. For example, all of the steps included in the treatment package may be displayed as a list with the required time for each step. According to the above, the user can easily confirm the treatment contents. Among the steps included in the treatment package, the reserved contents can be suitably changed. For example, some of the steps which take time can be omitted.

After the treatment reserved by the user starts, all of the steps included in the treatment package being performed can be displayed as a list in the screen on the display 24. In this case, when the estimated required time is updated by the reservation management server 3 based on the progress status, the information such as the latest estimated required time is displayed as necessary on the display 24.

The steps that are already finished may be erased from the list on the screen or the color may be changed and displayed. With this, it is possible to show in real time the progress status of the treatment by showing which step among all steps is being performed.

According to the above, it is possible to confirm as necessary what kind of steps are remaining and the time necessary to finish all steps. Therefore, it is easy for the user to understand, and the user is able to receive the treatment comfortably.

The user who checks the screen showing the list may be able to suitably change the “reserved contents” (treatment package), for example, omit some steps in the reserved treatment package, or add optional steps. In this case, the input contents are transmitted to the reservation management server 3 as necessary, and the estimated required time is updated in the reservation management server 3 according to the changed contents.

When the input screen of the reserved contents is opened as the operation screen, the user is able to select and set the desired treatment package.

As the “reserved contents” input on the input screen of the reserved contents, as described above, the following examples are assumed, the finger including the nail on which the printing is performed (10 fingernails of both hands, 5 fingernails of each of the left or right hand, etc.), whether the base coat needs to be applied, when the base coat is applied, whether the user desires the base coat to be applied manually by the store staff, selection of the design that the user desires to be printed as the nail design, whether the decoration process is performed, whether supplementary tasks such as haircuts are performed together with the nail printing which is the main task, etc.

Even if the treatment is performed on the same number of nails, the price may change depending on whether the base coat is applied by printing white ink with the printing apparatus 1 or whether the base coat is applied manually by the store staff. Even when the base coat is applied manually, the price of the package in which the staff with high skills is appointed becomes higher than the package in which the staff is not appointed. Therefore, preferably, the difference in the price depending on such different selections are also displayed on the input screen of the reserved contents.

According to the present embodiment, various instructions such as the start of printing may be output from the terminal apparatus 2 to the printing apparatus 1 when the user operates the operator 23. The user may be able to select the design (nail design) to be printed on the nail when the user operates the operator 23. In such configuration, the terminal apparatus 2 functions as the operator of the printing apparatus 1.

For example, the display 24 includes a liquid crystal display (LCD), an organic electroluminescent display (organic ELD), or other display device 241 (flat display). The display 24 displays various images and information on the display device 241 based on the display signal input from the controller 21.

For example, the nail design input and selected by the user on the operator 23, various guide screens, warning display screens, various images imaged by the camera 51 of the printing apparatus 1 and the like can be displayed on the display 24.

According to the present embodiment, information regarding the store searched by the user, the reservation status of the treatment performed by the printing apparatus 1 provided in such store, the estimated required time for the user who already made the reservation and the progress status of the treatment are sent from the later-described reservation management server 3 to the terminal apparatus 2. The above information are displayed as necessary on the display 24.

The display device 241 of the display 24 according to the present embodiment is formed as one with the touch panel and is able to accept the touch operation by the user. The touch panel included in the display device 241 functions as the operator 23 to perform various input.

When the touch panel functions as the operator 23, as described above, input to reserve the task including a plurality of steps can be performed by touch operation on the touch panel. Moreover, the input of the progress status of each step can be performed by touch operation on the touch panel.

The communicator 25 is able to connect with the network N similar to the communicator 19 of the printing apparatus 1. For example, the terminal apparatus 2 transmits and receives information with the later-described reservation management server 3 through the communicator 25.

The information received from the reservation management server 3 can be suitably stored in the storage 22, etc. Moreover, various display data may be generated based on the information received from the reservation management server 3 and the various screens may be displayed on the display 24 based on the display data.

When the terminal apparatus 2 transmits data that is a design (nail design) printed on the nail by the printing apparatus 1, for example, data is transmitted and received by wireless communication based on short-range wireless communication standards such as Bluetooth (registered trademark), WiFi, etc., communication by wireless LAN, communication by wired communication, and the like. The method of communication is not limited. The method of communication may be suitably selected from various communication methods.

### [Configuration of Reservation Management Server]

The reservation management server 3 is a server that acquires and manages the reservation status of the printing apparatus 1 connected to the network N.

When the reservation status, etc. is managed by the reservation management server 3, the printing apparatus 1 is a printing apparatus provided in an affiliated store or cooperating store (affiliated nail salon or beauty salon). The printing apparatus 1 is registered in a registration management system 100 and is able to perform reservation procedures by accessing to the reservation management server 3.

FIG. 5 is a block diagram of a main portion showing the functional configuration of the reservation management server.

As shown in FIG. 5, the reservation management server 3 includes a control apparatus 30, a communicator 35, and the like.

The control apparatus 30 is a computer including a controller 31 including a processor such as a CPU (not shown) and a storage 32 including a ROM and a RAM (both not shown).

A reservation management information storage region 322 is provided in the storage 32. A reservation management program 321 executed when the controller 31 performs the reservation management process and various information necessary to perform the reservation management process are stored in the reservation management information storage region 322.

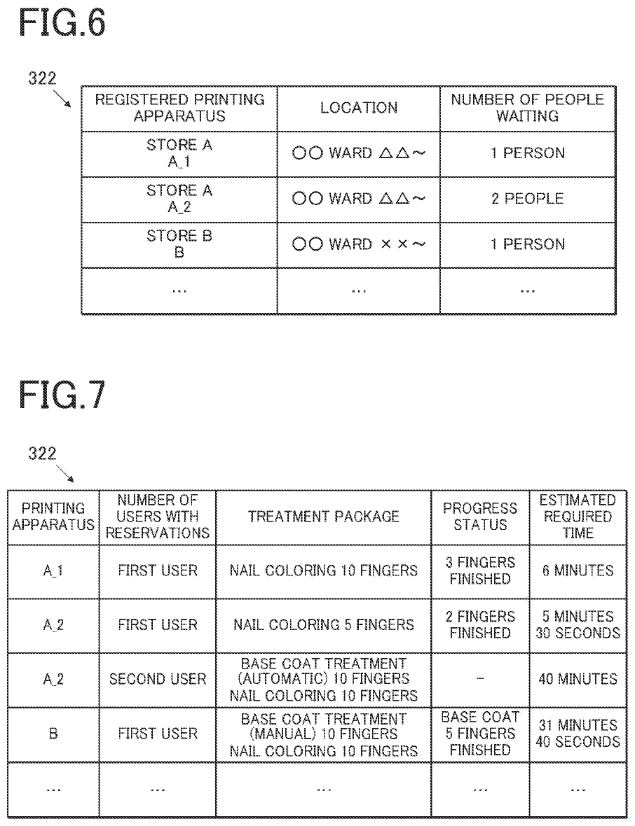

FIG. 6 and FIG. 7 show an example of the information stored in the reservation management information storage region 322.

For example, FIG. 6 shows an example of the information in which the printing apparatus 1 registered in the reservation management system 100 of the present embodiment is corresponded with the location of the printing apparatus 1 and the number of people who are waiting (that is, the number of people who are reserving the printing apparatus 1 at the present time). The above information is stored.

FIG. 7 shows an example of the information in which the identification number of the printing apparatus 1 (A_1, A_2, etc. shown in FIG. 1) is corresponded with the number of users reserving each apparatus, the treatment package which is the “reserved contents” of each user, the progress status of each user, and the newest “estimated required time”. The above information is stored.

The “nail coloring” in the treatment package shown in FIG. 7 is the treatment to draw a design (nail design) on the surface of the nail (printing target surface) and includes the case in which the staff such as a manicurist colors the nail manually. The example in FIG. 7 assumes treatment in which the design (nail design) is printed on the surface of the nail (printing target surface) using the print head for design printing that can eject color ink among the print heads 171 provided in the printing apparatus 1. The “base coat treatment (automatic)” is the treatment in which the print head for the base coat among the print heads 171 is used to print liquid that is to be the base coat (for example, base coat ink such as white ink). Further, the “base coat treatment (manual)” is the treatment in which the person in charge of the treatment such as the staff of the store applies the base coat manually. The information stored in the reservation management information storage region 322 is updated as necessary each time new information is accepted in the reservation management server 3. The information stored in the reservation management information storage region 322 is not limited to the examples shown here.

The controller 31 controls each unit of the reservation management server 3. The controller 31 reads the specified program among the system program and the application programs stored in the storage 32, deploys the program in the work area of the RAM, and performs various processes according to the program.

As described above, the reservation management program 321 is stored in the storage 32 of the present embodiment. In coordination with the reservation management program 321, the controller 31 performs various functions to manage the reservation such as accepting the reservation, accepting the progress status, deriving the estimated time, updating the estimated time, calculating the waiting time, controlling the output, and the like.

The controller 31 as the reservation acceptor accepts the reservation regarding the task including the plurality of steps for each user. According to the present embodiment, when the reservation of printing on the nail that is performed using the printing apparatus 1 is input by the user from the operator 12 (including touch panel) of the printing apparatus 1 and the operator 23 (including touch panel) of the terminal apparatus 2, the information regarding the reservation is transmitted to the reservation management server 3 through the communicator 35, and such reserved contents is accepted by the controller 31 of the reservation management server 3.

For example, when the reservation of the printing on the nail is made, there may be cases in which the user performs some of the “plurality of steps” included in the printing of the nail which is the task (treatment) at home in advance. In such case, the user may make the reservation for only the remaining steps as the contents to be performed at the store. Specifically, the user may apply the base coat and the top coat manually at home, and may visit the store only to print the design (nail design) by using the printing apparatus 1. Therefore, the controller 31 as the reservation acceptor does not have to accept the reservation for all steps in the task including the plurality of steps. The controller 31 is to accept the reservation for at least one step.

The controller 31 as the progress status acceptor accepts input of the progress status of each step included in the task (reserved treatment, reserved contents). When the progress status of the steps in the contents reserved by the user and accepted by the controller 31 as the reservation acceptor changes (for example, when a step ends, when the process progresses to the next step, etc.), the progress status is notified automatically from the controller 101 of the printing apparatus 1 to the reservation management server 3 (automatic input of progress status). When the progress status is input by the staff of the store from the operator 12 of the printing apparatus 1 and the operator 23 of the terminal apparatus 2, the information regarding the input progress status is transmitted to the reservation management server 3 through the communicator 35 (manual input of progress status). The progress status automatically input (notified) from the printing apparatus 1 and the terminal apparatus 2 or the progress status input manually is accepted in the controller 31 of the reservation management server 3.

According to the present embodiment, the “reserved contents” is contents of the treatment or the treatment package that the user desires to receive. The “plurality of steps” included in the task (treatment) is different depending on the treatment package desired by the user.

For example, when the user desires to perform the printing on the nail, and the user selects the treatment package in which the base coat is applied manually by the technician (store staff, etc.), and the printing of the design (nail design) is performed using the printing apparatus 1, the “plurality of steps” included in the task (treatment) is to be as follows, for example.

That is,

Step A: Base coat applying step in which liquid (first coating agent, for example, white ink) that is to be the base coat is applied to all nails in which the treatment (printing, etc.) is desired.
Step B: Coating agent drying step that dries the applied liquid (first coating agent) that is to be the base coat.
Step C: Receptive layer forming step that applies liquid (second coating agent) that forms a receptive layer to fix the ink (color ink in various colors) for forming the design on all nails in which the treatment (printing, etc.) is desired.
Step D: Receptive layer drying step that dries the liquid (second coating agent) that forms the receptive layer.
Step E: Design printing step that applies the ink for forming the design on all nails in which the treatment (printing, etc.) is desired.
Step F: Ink drying step that dries the ink for forming the design.
Step G: A top coat agent applying step that applies the top coat agent (coating agent to prevent the ink printed on the nail from coming off, third coating agent) on all nails in which the design is printed.
Step H: A top coat drying step that dries the applied top coat agent (third coating agent).

For example, when the user desires to perform the printing of the nail, and the user selects the treatment package in which the applying of the base coat is also automatically performed using the printing apparatus 1, the “plurality of steps” included in the task (treatment) is to be as follows, for example.

That is,

Step A_1: Pre-coating applying step that applies pre-coating agent (coating agent to prevent ink going into the nail, first 1 coating agent) on all nails in which the treatment (printing, etc.) is desired.
Step B_1: Pre-coating drying step that dries the applied pre-coating agent (first 1 coating agent).
Step C_1: Base coat ink receptive layer forming step that applies liquid (second 1 coating agent) that forms the receptive layer that fixes the base coat ink (white ink, etc.) for all nails in which the treatment (printing, etc.) is desired.
Step D_1: Base coat ink receptive layer drying step that dries the liquid (second 1 coating agent) that forms the receptive layer.
Step A_2: Base coat applying step that applies the base coat ink (for example, white ink) on all nails in which the treatment (printing, etc.) is desired.
Step B_2: Base coat drying step that dries the applied base coat ink (white ink, etc.).
Step C_2: Color ink receptive layer forming step that applies liquid (second 2 coating agent) that forms the receptive layer to fix the color ink (color ink in various colors for designs) on all nails in which the treatment (printing, etc.) is desired.
Step D_2: Color ink receptive layer drying step that dries the liquid (second 2 coating agent) that forms the receptive layer.
Step E: Design printing step that applies the ink for forming the design on all nails in which the treatment (printing, etc.) is desired.
Step F: Ink drying step that dries the ink for forming the design.
Step G: A top coat agent applying step that applies the top coat agent (coating agent to prevent the ink printed on the nail from coming off, third coating agent) on all nails in which the design is printed.
Step H: A top coat drying step that dries the applied top coat agent (third coating agent).

Step E and the steps thereafter in the example using the printing apparatus 1 to apply the base coat are the same when the base coat is applied manually.

The steps shown here are one example. All of these steps do not have to be included, and other steps may be included.

When the printing of the nail is performed on the nail, in addition to step A (step A_1) to step H, the design (nail design) that the user desires to print on the nail needs to be set.

The setting of the design can be performed by input on the user's terminal apparatus 2 when the user makes the reservation or by operating the touch panel of the display 13 (or the portable terminal such as the tablet PC that is a separate device from the printing apparatus 1 but is linked to the printing apparatus 1) of the printing apparatus 1 after arriving at the store. In the latter case, the user may set the desired design at least before step E in which the design is printed. The desired design may be the design stored in the storage 102 of the printing apparatus 1 or the user may download the desired design from an external server to the user's terminal apparatus 2 and prepare the desired design. The design created by the user or a cutout from a photograph stored in the terminal apparatus 2 may be used.

In addition to the steps described above, a step in which the person in charge of the treatment such as the staff of the store provides advice on the design that is drawn (for example, a consulting step to select the design) may be included in the “plurality of steps” included in the task (treatment).

The “reserved contents” and the “progress status” accepted by the controller 31 are stored in the reservation management information storage region 322 of the storage 32.

The time necessary for each step is set in advance and stored in the storage 32.

For example, when the ink is applied manually by the technician (the above-described step A to step C), and it is set that 1 minute is necessary for each nail, the time required to perform the treatment on 10 fingernails for both hands is 10 minutes.

For example, when the printing is performed using the printing apparatus 1 (above-described step E and step C_1), and it is set that 10 seconds are necessary for each nail, the time required to perform the treatment on 10 fingernails for both hands is 100 seconds.

For the steps in which the ink applied to the 10 fingernails for both hands is dried by the drying mechanism 18 (above-described step B, step D, and step F), the average required time that is to be a rough indication is stored in the storage 32 for each step, for example, 5 minutes.

The average required time for the user who performed the treatment in the past under the same conditions may be set as the time required for each step (initial required time).

The method to store the required time is not limited to the above. For example, the required time may be stored as a table corresponded with each step (corresponded with the required time of XX seconds when one nail is printed, for example).

When the ink is applied by hand by the technician, the required time that is set may be differed depending on the skills of the technician. That is, if the technician has a history in practice that is less than 1 year, it may be set that 2 minutes are necessary for 1 nail, and when the technician is a veteran and has a history in practice that is 5 or more years, it may be set that 40 seconds are necessary for 1 nail. If there is a ranking for skills recognized in the industry, the set required time may be changed depending on the rank of the technician who is in charge of the treatment.

Even when the applying is performed manually by the same technician, the required time may be set differently depending on the contents of the treatment. For example, the required time that is set for applying the base coat ink may be set to be longer than the required time for applying the pre-coating agent.

The controller 31 as the estimated time deriver derives the “estimated required time” necessary for all of the processes in the reserved task.

That is, when the “reserved contents” is accepted, the controller 31 reads the rough indication of the required time for each step from the storage 32 and adds the time for all steps included in the reserved contents. With this, the time necessary to perform all of the steps in the task is obtained as the “estimated required time”.

For example, when the rough indication of the required time is as described in the above example and the user selects the treatment package in which the base coat is applied automatically using the printing apparatus 1, 40 minutes is derived as the “estimated required time” necessary for performing all of the steps in the task. Among the above steps, when the ink is applied manually in step A_1 (pre-coat applying step), C_1 step (base coat ink receptive layer forming step), C_2 step (color ink receptive layer forming step), and G step (top coat applying step), for example, a required time that is 30 minutes or more longer than the above is derived. Whether the above steps are performed manually or by the printing apparatus 1 depends on the ink cartridge provided in each printing apparatus 1. Therefore, regarding step A_1 (pre-coat applying step), step C_1 (base coat ink receptive layer forming step), step C_2 (color ink receptive layer forming step), and step G (top coat applying step), it is preferable to register in advance in the reservation management server 3 which printing apparatus 1 is used for printing which step and to derive the “estimated required time” according to the contents registered in the reservation management server 3.

When the progress status of the task is accepted on the controller 31 of the reservation management server 3, the controller 31 as the estimated time updater updates the “estimated required time” based on the accepted progress status.

For example, in a task in which the “estimated required time” is derived to be 40 minutes, if the progress status is that step A_1 to step D_1 are finished and four fingers are finished in the base coat applying step (step A_2) in which the base coat ink is applied to the nail, the amount of time consumed in the steps that are finished is subtracted from the initial “predicted required time” and the “predicted required time” is updated to 26 minutes.

When there are a plurality of reserved tasks, the controller 31 adds the “estimated required time” derived for all of the steps in the reserved task and functions as the waiting time calculator that calculates the “waiting time” for the user who is reserving the printing apparatus 1 next.

That is, when there is 1 user who already reserved the printing apparatus 1 that the user intends to reserve (for example, printing apparatus A_1 provided in the store A), if the “estimated required time” for this user is 6 minutes, the “waiting time” for the next user who reserves the printing apparatus 1 is 6 minutes. Further, when there are 2 users who already reserved the printing apparatus 1 that the user intends to reserve (for example, printing apparatus A_2 provided in the store A), if the “estimated required time” for the first user is 5 minutes 30 seconds and the “estimated required time” for the second user is 40 minutes, the “waiting time” for the next user who reserves the printing apparatus 1 is 45 minutes 30 seconds.

The controller 31 also functions as the output controller that outputs the “estimated required time”.

When the “estimated required time” is derived, the “estimated required time” is updated, or the “waiting time” is calculated, the latest (updated) “estimated required time” is stored in the reservation management information storage region 322. When there is access from the printing apparatus 1 or the terminal apparatus 2 to the reservation management server 3, the latest “estimated required time” stored in the reservation management information storage region 322 is suitably output to the printing apparatus 1 or the terminal apparatus 2.

The timing that the updated contents is transmitted may be when viewing of the information is requested to the reservation management server 3, such as when the printing apparatus 1 or the terminal apparatus 2 accesses to the reservation management server 3. The destination that the controller 31 outputs the “estimated required time” is not limited to the printing apparatus 1 and the terminal apparatus 2. For example, the information such as the “estimated required time” can be output so as to be displayed on a display provided in each store, an apparatus that can be widely visible to users or a bulletin board of a site that can be shared among users.

### [Reservation Management Method]

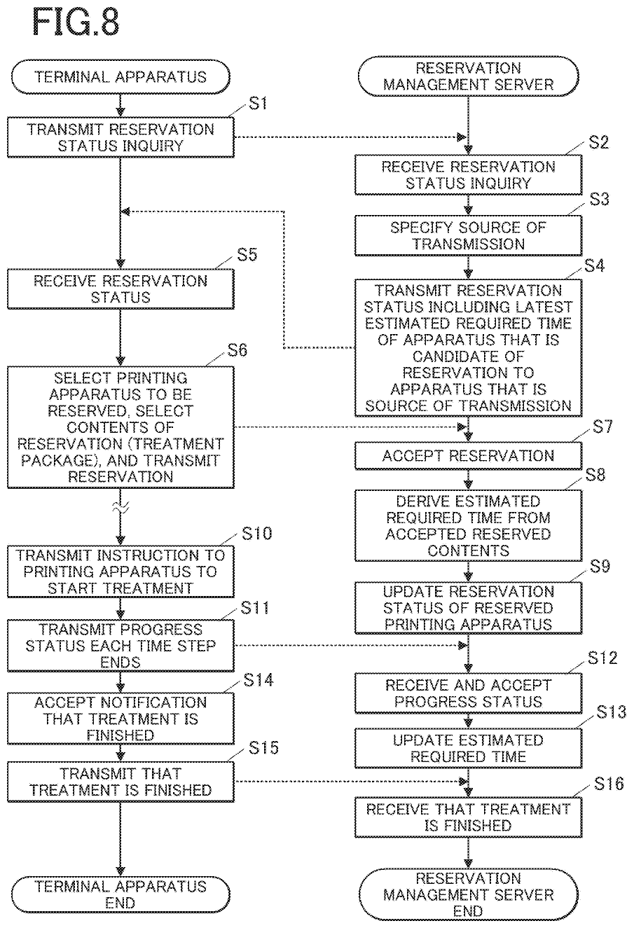

Next, with reference to FIG. 8, the reservation management method according to the present embodiment is described.

FIG. 8 is a flowchart showing a process in the reservation management method according to the present embodiment.

FIG. 8 shows an example when the user makes a reservation of the treatment using the terminal apparatus 2 from outside the store, and the user inputs the progress status to the reservation management server 3 through the terminal apparatus 2 after the treatment starts.

In this case, the user operates the operator 23 (touch panel, etc.) of the terminal apparatus 2 outside the store in which the printing apparatus 1 is provided (outside, or at home, at the workplace, etc.), and as shown in FIG. 8, inquires about the reservation status of the printing apparatus 1 (step S1). By narrowing down the range to the area that the user desires to search or the present position of the user, the user is able to make an inquiry about the reservation status of the printing apparatus 1 provided in the store that is easy to access to the user.

The inquiry input from the operator 23 is transmitted to the reservation management server 3 through the network N, and the inquiry is received by the controller 31 of the reservation management server 3 (step S2).

The controller 31 of the reservation management server 3 specifies the apparatus that is the source of the transmission by referring to the address information of the terminal apparatus 2 that made the inquiry (step S3). Then, the reservation status including the latest estimated required time of the printing apparatus 1 which is to be the candidate of the reservation is transmitted to the apparatus that is the source of the transmission (step S4).

In this case, the range of the printing apparatus 1 that is to be listed as the candidate of the reservation is suitably set. For example, when the user makes the inquiry of the reservation, if the user specifies the store or the area that the user desires to inquire the reservation status, the list is made according to the items specified by the user. For example, when it is possible to specify the present position of the terminal apparatus 2 of the source of transmission from the position information, etc. of the GPS, even if the user does not specify the desired store or area, only the printing apparatus 1 positioned in the location closest to the apparatus that is the source of transmission may be considered to be the candidate of the reservation, and the reservation status of the apparatus may be transmitted. Alternatively, for example, all of the printing apparatuses 1 in a range within a certain distance from the apparatus that is the source of transmission may be listed as the candidate of reservation. Alternatively, for example, a certain number of apparatuses may be listed as the apparatus that is the candidate of reservation in order from the printing apparatus 1 that is close to the present position of the terminal apparatus 2 (for example, top 10 close apparatuses). Further, when such plurality of printing apparatuses 1 are candidates of reservation, the apparatuses with available spots in the reservation status may be listed with priority.

The reservation status notified to the terminal apparatus 2 in response to the inquiry from the user may be set considering the time necessary for the user to move from the present position to the store where the printing apparatus 1 is provided. For example, when the user inquires about the reservation status of the store at a distance that takes 30 minutes using transportation systems such as the train from the present position, considering the time necessary for the user to travel, the reservation status 30 minutes later may be notified.

In this case also, the reservation status transmitted to the terminal apparatus 2 of the user is notified with the latest estimated required time updated after reflecting in real time the progress status of the reserved contents that are reserved or in which the treatment is already started at the present time.

When the terminal apparatus 2 that is the source of the inquiry receives the information regarding the reservation candidates and their reservation status (step S5), the received contents are displayed on the display device 241 of the display 24. The reservation status of each printing apparatus 1 may be displayed on the screen in which the printing apparatuses 1 that are the candidates of reservation are displayed as a list. Alternatively, detailed information such as the reservation status of the apparatus may be displayed when any of the printing apparatuses 1 is selected (tap operation on the touch panel, for example) on the screen listing the printing apparatuses 1.

Based on the displayed information, the user selects the printing apparatus 1 to be reserved on the operator 23, etc., selects the reserved contents (that is, the desired treatment package) and makes an input to confirm the reservation. With this, the reserved contents are output to the controller 21, and the reserved contents is transmitted to the reservation management server 3 from the terminal apparatus 2 (step S6).

When the reservation is received and accepted from the terminal apparatus 2 (step S7), the controller 31 of the reservation management server 3 derives the estimated required time necessary to perform the treatment in the reserved contents from the accepted reserved contents (step S8). The controller 31 of the reservation management server 3 updates the reservation information regarding the reserved printing apparatus 1 (step S9).

Specifically, the reserved contents and the estimated required time derived based on the reserved contents are corresponded with the identification number of the printing apparatus 1, and the above are stored in the reservation management information storage region 322. That is, for example, new reservation information is added to the list stored in the reservation management information storage region 322 shown in FIG. 7. The added reservation information and the list in the reservation management information storage region 322 including the above information may be transmitted from the reservation management server 3 to the terminal apparatus 2 that is the source of the reservation or the printing apparatus 1 that is the destination of the reservation and the data can be shared.

The user of the terminal apparatus 2 that is the source of the reservation visits the store in which the printing apparatus 1 that accepted the reservation is provided. Then, when the printing apparatus 1 is ready to perform the treatment, the user receives the treatment according to the reserved contents. Specifically, for example, when the user reaches the store, the user selects the design (nail design) that the user desires to print on the nail and the instruction to start the treatment is transmitted to the printing apparatus 1 (step S10). By transmitting the instruction to start the treatment from the terminal apparatus 2 to the printing apparatus 1, pairing may be established between the printing apparatus 1 and the terminal apparatus 2 of the user for this treatment. With this, the printing apparatus 1 outputs various signals to the terminal apparatus 2 that transmitted the instruction to start the treatment.

When the user receives the treatment to apply the base coat by the store staff before printing by the printing apparatus 1, the user receives the treatment manually.

For example, when the pre-coating agent is applied (above-described step A_1) automatically by the printing apparatus 1, a notification indicating that the applying of the pre-coating agent is finished for a certain nail is notified (output) from the printing apparatus 1 to the terminal apparatus 2 each time the applying is finished for the certain nail, and the above is input (transmitted) from the terminal apparatus 2 to the reservation management server 3 automatically as the progress status (step S11). Preferably, the input (transmitting) is performed in small units such as each time the process for one nail ends so that it is possible to understand the reservation status (progress status) closer to real time. The output of the progress status is not limited to each time the process for one nail ends. For example, the progress status showing that the step to apply the pre-coating agent (step A_1) is finished may be transmitted to the reservation management server 3 at the timing that the process for 5 fingers in one hand or 10 fingers in both hands ends.

The input (transmitting) of the progress status is not limited to automatically performing from the terminal apparatus 2 (terminal apparatus 2 that received the notification from the printing apparatus 1).

For example, when the staff of the store inputs that a step performed manually is finished from the operator 12 of the printing apparatus 1 or the operator 23 of the terminal apparatus 2, the signal according to the input contents may be transmitted to the reservation management server 3. Alternatively, when the step to apply the base coat is performed manually, the staff of the store who is performing the treatment may operate the end button of the apparatus that can communicate with the reservation management server 3 each time the step ends and the progress status may be transmitted to the reservation management server 3.

When the progress status is received from the terminal apparatus 2, the controller 31 of the reservation management server 3 accepts the progress status (step S12) and the estimated required time is updated according to the newly received progress status (step S13). Specifically, the contents stored in the reservation management information storage region is rewritten as necessary according to the updated information. When there is an inquiry to the reservation management server 3, the updated reservation status is transmitted to the user.

With this, another user that accessed to a reservation site from another printing apparatus 1 or the user's terminal apparatus 2 at this point is able to know the reservation status in real time with the progress status progressing, and the user is able to know the accurate waiting time if the user makes the reservation at this point.

In the printing apparatus 1, when all of the treatment contents in the reserved contents (reserved treatment package) ends, the notification that the treatment is finished is transmitted from the printing apparatus 1 to the terminal apparatus 2, and the notification is accepted by the terminal apparatus 2 (step S14). The terminal apparatus 2 transmits the notification that the treatment is finished received from the printing apparatus 1 to the reservation management server 3 (step S15), and the process ends.

The reservation management server 3 ends the series of processes when the reservation management server 3 receives that the treatment is finished from the terminal apparatus 2 (step S16).

Here, the user checks the reservation status of the printing apparatus 1 using the terminal apparatus 2 such as the user's smartphone from outside such as outside the store, and the user makes the reservation. However, making a reservation of the treatment is not limited to the above example. For example, the user may visit the store in which the printing apparatus 1 is provided. Then, the user may check the reservation status from the operator 12 of the printing apparatus 1 and make a reservation.

In this case, other than the point that the printing apparatus 1 itself is able to identify the start of the treatment in step S10 and the end of the treatment in step S14 as shown in FIG. 8, similar processes are performed.

In a situation in which the reservation status is checked and the reservation is made from the operator 12 of the printing apparatus 1, when the list of the apparatuses which are to be the candidates of the reservation is made in step S3, the printing apparatus 1 that made the inquiry of the reservation status is identified by the identification number (for example, printing apparatus A_1 provided in the store A) and only the specified printing apparatus may be provided as the candidate of the reservation. Then, the reservation status of this apparatus is transmitted. When the apparatus that transmitted the inquiry is the printing apparatus A_1 provided in the store A, the printing apparatus A_2 that is provided in the same store as the printing apparatus A_1 may be the candidate of the reservation and the reservation status of the two apparatuses may be transmitted. Moreover, all of the printing apparatuses 1 within a certain distance of the apparatus that transmits the inquiry may be listed as the candidate of the reservation. When the plurality of printing apparatuses 1 are candidates of the reservation, the apparatuses with available slots in the reservation status may be listed with priority or the apparatuses that are close to the apparatus that is the source of transmitting the inquiry may be listed with priority.

As described above, according to the present embodiment, the progress status of the treatment is updated each time the step ends. Therefore, the user is able to know the reservation status in real time and it is possible to provide useful information to the user who desires to make a reservation of the treatment after viewing the reservation status.

As described above, the reservation management system 100 according to the present embodiment includes a controller 31. The controller 31 includes the following functions. The reservation accepting function accepts the reservation of at least one step in a task including a plurality of steps for each user. The estimated time deriver derives the estimated amount of time necessary for all of the steps in the task to be performed for the reserved steps (task) reserved by each user. The progress status accepting function accepts input of the progress status of each step for each user. The estimated time updating function updates the estimated required time based on the input progress status.

With this, the reservation status of the treatment according to the detailed progress status for each step can be provided to the user. Therefore, when the user desires to make a reservation of the treatment within a short amount of spare time, the user is able to know in real time the reservation status considering the progress status of the task performed in the previous reservation. With this, the user is able to make a suitable reservation.

Moreover, it becomes easier for the user to make a reservation within a short amount of spare time. Therefore, for example, when the present reservation management system 100 is applied to the reservation management of the treatment by the printing apparatus 1, the operating rate of the printing apparatus 1 can be enhanced.

According to the present embodiment, when the controller 31 functions as the output controller that outputs the estimated required time, the latest estimated required time suitably updated according to the change in the progress status is output to the terminal apparatus 2 and the printing apparatus 1, and the estimated required time is displayed as necessary on the display 24 and the display 13.

Therefore, the user is able to easily check the latest estimated required time, and is able to make use of this information when making the reservation of the printing apparatus 1. The user who is receiving the treatment is able to know how long it will take until the treatment will be finished. Therefore, the user is able to receive the treatment comfortably and is able to make use of the information for making plans after the treatment.

According to the present embodiment, the task including a plurality of steps is printing a design on the nail.

When a task including a plurality of steps such as printing on the nail is performed, it is difficult to monitor the progress status and to estimate the waiting time. In the present embodiment, the progress status of each step is accepted, and the estimated required time is updated as necessary. Therefore, even if there is another user who already reserved the printing apparatus 1 that the user desires to reserve, the user is able to estimate the waiting time relatively accurately.

According to the present embodiment, the input of the progress status is performed each time the step ends.

Therefore, if there is another user who already reserved the printing apparatus 1 that the user desires to reserve, it is possible to monitor in real time the progress status of the user. With this, the user is able to estimate how long the user needs to wait until the user can receive the treatment if the user makes the reservation. That is, the user is able to estimate the waiting time relatively accurately.

According to the present embodiment, the controller 31 functions as the waiting time calculator. When there are a plurality of reserved tasks, the “estimated required time” derived from the time required for all of the steps in each reserved task is added and the “waiting time” for the user who made the next reservation is calculated.

With this, when the plurality of users are reserving the printing apparatus 1, the user who desires to reserve next does not need to calculate for himself how long the waiting time is if the user makes the reservation at this point. That is, the user is able to easily confirm the expected “waiting time”.

According to the present embodiment, the output controller outputs the estimated required time to the terminal apparatus of the user whose reservation is accepted.

With this, the user who already made the reservation is able to estimate how long they need to wait until they can receive the treatment. Therefore, the user can wait with relatively no stress.

According to the present embodiment, the output controller outputs the estimated required time to the terminal apparatus of another user different from the user whose reservation is accepted.

With this, it is possible to show the accurate estimated required time to the user who is thinking of receiving the treatment using the spare time. Such information can be provided for reference to the user in determining whether it is possible to make the reservation according to the convenience of the user.

According to the present embodiment, when there is a main task and a supplementary task, the reservation acceptor accepts the setting of the steps in the supplementary task also. The estimated time deriver derives the estimated required time by adding the steps in the supplementary task to the total number of steps in the main task.

For example, if the printing apparatus (nail print apparatus) is positioned in the place (store) where tasks other than nail printing is performed such as a beauty salon, depending on the time required to perform the tasks different from the nail printing such as hair cuts, the time that the printing apparatus can be used may change. In such case, the time necessary for tasks other than nail printing such as hair cuts can be considered, and with this, the estimated required time can be derived more accurately.

According to the present embodiment, when there is a difference in the time that is required for the task due to the skills of the person who performs the task, and the controller 31 as the estimated time deriver derives the estimated required time according to the skills of the person who performs the task, the estimated required time can be derived more accurately.

Embodiments of the present disclosure are described, however, the present disclosure is not limited to the above embodiments, and various modifications are possible without leaving the scope of the disclosure.

For example, the above embodiment shows an example in which the display 13 of the printing apparatus 1 is formed as one with the printing apparatus 1. Alternatively, for example, the display 13 does not have to be provided in the printing apparatus 1. A terminal apparatus that is a different device can be linked to the printing apparatus 1, and such terminal apparatus may be provided with a display that includes the operator and the touch panel.

According to the present embodiment, a plurality of printing apparatuses 1 are registered in the reservation management system 100, but alternatively, the printing apparatus 1 that is registered in the reservation management system 100 may be one device.

The printing apparatus 1 is not limited to the printing apparatus provided with a print head for printing the design and the print head for printing the base coat. For example, the printing apparatus 1 registered in the reservation management system 100 may include an apparatus dedicated to printing the design including only the print head for design printing, and an apparatus dedicated to printing the base coat including only the print head for the base coat. Further, a drying machine different from the printing apparatus 1 may be provided as the drying mechanism 18. When separate devices are provided for the different functions, the reservations can be accepted for the design printing, the base coat printing, and the like, to perform such processes in parallel. As described above, when each step is performed by separate devices, and the tasks can be performed in parallel, the waiting time is decreased even more and the reservation management becomes more efficient.

The device that performs the various functions to manage the plurality of reservations such as the reservation accepting function, the progress status accepting function, the estimated time deriving function, the estimated time updating function, the waiting time calculating function, and the output control function is not limited to the controller 31 of the reservation management server 3. For example, the controller 101 of the printing apparatus 1 or a controller of a terminal apparatus linked to the printing apparatus 1 may perform the functions.

In this case also, when the user attempts to make a reservation from the user's terminal apparatus 2, the user is able to know the reservation status in real time reflecting the present progress status.

For example, when there is only one printing apparatus 1 registered in the reservation management system 100, the reservation information of the plurality of printing apparatuses 1 does not have to be managed centrally, and the system can be established with a simple configuration.

According to the present embodiment, the reservation management system 100 is assumed to manage nail printing using the printing apparatus 1. However, the reservation management system 100 is not limited to managing treatment including nail printing using the printing apparatus 1.

The reservation management system 100 can be applied to any treatment if the task includes a plurality of steps and the progress status of the steps can be notified as necessary to the reservation management server 3. For example, if the technician inputs the progress of each step for hair cuts in a beauty salon or at a nail salon that does not use the printing apparatus 1 (for example, steps for a hair cut may be, shampoo, cutting, blow drying, etc.), and this is notified to the reservation management server 3 as necessary, the reservation management can be performed according to the progress status in the operation performed by the technician.

According to the present embodiment, the storage 22 of the terminal apparatus 2 is provided with the design data storage region 222, and the data of the design (nail design) is stored in the design data storage region 222. However, the data of the nail design does not have to be stored in the storage 22 of the terminal apparatus 2, and may be stored in the storage 102 of the printing apparatus 1.

The image data of the nail design can be stored in a server apparatus that can be connected through a network line, etc. Access can be made to the server apparatus and the data of the nail design can be referred.

According to the above, the user is able to select the design to be printed from a large variety of nail designs without increasing the capacity of the storage 22.

Although various embodiments of the present disclosure have been disclosed and described, the scope of the present disclosure is not limited to the embodiments above. The present disclosure includes the scope of the attached claims and its equivalents.

What is claimed is:

1. A reservation management system comprising at least one processor configured to:
accept a reservation of at least one step in a task including a plurality of steps, wherein the step is performed for each user,
derive estimated required time that is necessary to perform an entire task including the reserved step performed for each user,
accept input of a progress status of each step performed for each user, and
update the estimated required time based on the input progress status.

2. The reservation management system according to claim 1, wherein the task including the plurality of steps is nail printing in which a design is printed on a nail.

3. The reservation management system according to claim 1, wherein the input of the progress status is performed each time each step ends.

4. The reservation management system according to claim 1, wherein, when there are a plurality of reserved tasks, the at least one processor is configured to add the estimated required time derived for the entire task of each of the plurality of reserved tasks, and calculate waiting time for the user who reserves next.

5. The reservation management system according to claim 1, wherein the at least one processor is configured to output the estimated required time.

6. The reservation management system according to claim 5, wherein the at least one processor is configured to output the estimated required time to a terminal apparatus owned by a user whose reservation is accepted.

7. The reservation management system according to claim 5, wherein the at least one processor is configured to output the estimated required time to a terminal apparatus owned by another user different from the user whose reservation is accepted.

8. The reservation management system according to claim 1,
wherein, when a supplementary task is performed in addition to a main task, the at least one processor is configured to accept setting of a step included in the supplementary task, and
wherein the at least one processor is configured to add the step included in the supplementary task to the entire task and derive the estimated required time.

9. The reservation management system according to claim 1, wherein, when there is a difference in the time required to perform the task depending on skills of a person performing the task, the at least one processor is configured to derive the estimated required time according to the skills of the person performing the task.

10. A reservation management method comprising:
accepting a reservation of at least one step in a task including a plurality of steps, wherein the step is performed for each user,
deriving estimated required time that is necessary to perform an entire task including the reserved step performed for each user,
accepting input of a progress status of each step performed for each user, and
updating the estimated required time based on the input progress status.

11. A non-transitory computer-readable storage medium having a program stored thereon for controlling a computer, wherein the program controls the computer to perform:
accepting a reservation of at least one step in a task including a plurality of steps, wherein the step is performed for each user,
deriving estimated required time that is necessary to perform an entire task including the reserved step performed for each user,
accepting input of a progress status of each step performed for each user, and
updating the estimated required time based on the input progress status.
